(19) United States
(12) Patent Application Publication
(10) Pub. No.: US 2026/0211481 A1
(43) Pub. Date: Jul. 23, 2026

(54) DSD WITH ADJUSTABLE POWER CREDIT ALLOCATION

(71) Applicant: Microchip Technology Incorporated, Chandler, AZ (US)

(72) Inventors: Hayes Hsueh, San Jose, CA (US); Pitamber Shukla, San Jose, CA (US); Salvatrice Scommegna, Cornate D'Adda (IT)

(73) Assignee: Microchip Technology Incorporated, Chandler, AZ (US)

(21) Appl. No.: 19/223,993

(22) Filed: May 30, 2025

Related U.S. Application Data
(60) Provisional application No. 63/747,258, filed on Jan. 20, 2025.

(51) Int. Cl. G06F 1/3296

(52) U.S. Cl. CPC G06F 1/3296

(57) ABSTRACT

A data storage device with adjustable power credit allocation, and a method of providing adjustable power credit allocation in a data storage device. The device includes a non-volatile memory media and a controller. Relevant operating conditions are quantified, including a number of program/erase cycles completed by the memory media and a temperature of the controller. Recommended power credit numbers are determined for relevant commands, including read, write, and erase, based on the quantified operating conditions. The power credit allocation for the data storage device is adjusted based on the determined recommended power credit numbers. More or fewer program/erase cycles may result in, respectively, raising or lowering the power credit allocation. Higher or lower temperatures may result in, respectively, lowering or raising the power credit allocation. The controller may adjust the power credit allocation based on the plurality of recommended power credit numbers using a look-up table or using a formula.

### RELATED APPLICATION

The present U.S. non-provisional patent application is related to and claims priority benefit of an earlier-filed U.S. provisional patent application titled “DSD with Adjustable Power Credit Allocation,” Ser. No. 63/747,258, filed Jan. 20, 2025. The entire content of the identified earlier-filed application is incorporated by reference as if fully set forth herein.

### FIELD

The present disclosure relates to data storage devices and methods of implementing them, and more particularly, the various examples described herein concern a data storage device with adjustable power credit allocation, and a method of providing adjustable power credit allocation in a data storage device.

### BACKGROUND

Data storage devices (DSDs), such as solid-state drives (SSDs), use non-volatile memory (NVM) media (e.g., NAND-based memory media) for data storage, and typically include application-specific integrated circuit (ASIC) controllers for managing read, write, and other operations. DSDs are typically used in enterprise computing data center solutions (DCS) and certain high-performance computing (HPC) applications, including artificial intelligence (AI). It is generally desirable to improve the performance and reduce the cost of DSDs, but it can be difficult to do so.

This background discussion is intended to provide related information, and is not necessarily prior art.

### SUMMARY

Examples provide an SSD or other DSD with adjustable power credit allocation, and a method of providing adjustable power credit allocation in an SSD or other DSD. Broadly, examples dynamically allocate power for NAND-based or other NVM operations based on relevant operating characteristics of the drive, such as NAND degradation, which may be determined based on a number of completed program-erase (P/E) cycles, and a power consumption of the controller, which may be determined based on a temperature of the controller. Examples advantageously provide more accurate power allocation which allows for more accurate power estimation for system level design, improves quality of service (QoS) and media reliability, and reduces the error rate by better managing the temperature of the controller.

In an example, a DSD with adjustable power credit allocation may include an NVM media and a controller. The controller may be configured to perform a plurality of functions, including the following. A plurality of relevant operating conditions may be quantified, including determining a number of P/E cycles completed by the NVM media and determining a temperature of the controller. A plurality of recommended power credit numbers may be determined for a plurality of commands based on the quantified plurality of relevant operating conditions. The plurality of relevant commands may include read, write, and erase commands. The power credit allocation for the DSD may be adjusted based on the determined plurality of recommended power credit numbers.

In another example, a method of adjusting a power credit allocation in a DSD may include the operations set forth below. The DSD may include an NVM media and a controller. A plurality of relevant operating conditions may be quantified, including determining a number of P/E cycles completed by the NVM media and determining a temperature of the controller. A plurality of recommended power credit numbers may be determined for a plurality of commands based on the quantified plurality of relevant operating conditions. The plurality of relevant commands may include read, write, and erase commands. The power credit allocation for the data storage device may be adjusted based on the determined plurality of recommended power credit numbers.

In another example, a method of adjusting a power credit allocation in an SSD may include the operations set forth below. The SSD may include a NAND-based NVM and a controller, and the operations may be performed as functions by the controller as follows. A plurality of relevant operating conditions may be quantified by the controller, including determining a number of P/E cycles completed by the NAND-based NVM media and determining a temperature of the controller. A plurality of recommended power credit numbers may be determined by the controller for a plurality of commands based on the quantified plurality of relevant operating conditions. The plurality of relevant commands may include read, write, and erase commands. The power credit allocation for the data storage device may be adjusted by the controller based on the determined plurality of recommended power credit numbers.

The preceding examples may further include any one or more of the following features. A lower number of P/E cycles may mean that the DSD will process more read and write requests, which may result in the controller adjusting the power credit allocation lower. A higher temperature of the controller may mean that the DSD will process more read and write requests, which may result in the controller adjusting the power credit allocation lower. A higher number of P/E cycles may mean that the DSD will process fewer read and write requests, which may result in the controller adjusting the power credit allocation higher. A lower temperature of the controller may mean that the DSD will process fewer read and write requests, which may result in the controller adjusting the power credit allocation higher. The controller may adjust the power credit allocation using a look-up table based on the determined plurality of recommended power credit numbers, or the controller may adjust the power credit allocation using a formula based on the determined plurality of recommended power credit numbers.

This summary is not intended to identify essential features of the examples, and is not intended to be used to limit the scope of the claims. These and other aspects of the present examples are described below in greater detail.

### DRAWINGS

Examples are described in detail below with reference to the attached drawing figures, wherein:

FIG. 1 is a high-level block diagram of components and functions of an example of a DSD incorporating adjustable power credit allocation;

FIG. 2 is a depiction of an over-estimated power credit allocation;

FIG. 3 is a depiction of an under-estimated power credit allocation;

FIG. 4 is a depiction of a more accurately estimated power credit allocation resulting from an example of the present disclosure;

FIG. 5 is a presentation, including a graph and a table, showing that a change in a temperature of a controller results in a change in a speed of operation for erasing an NVM media;

FIG. 6 is a presentation, including a graph and a table, showing that the same change in the temperature of the controller results in a change in a speed of operation for programming the NVM media;

FIG. 7 is a table showing that a change in a number of P/E cycles completed by the NVM media results in a change in a speed of operation for erasing the NVM media;

FIG. 8 is a table showing that the same change in the number of P/E cycles completed by the NVM media results in a change in a speed of operation for programming the NVM media;

FIG. 9 is a flowchart of operations in an example of a method of providing adjustable power credit allocation in a DSD; and

FIG. 10 is a portion of an example lookup table correlating recommended power credit numbers for an erase command with a change in temperature and P/E cycles for a particular device and a particular application.

The figures are not intended to limit the examples to the specific details depict. The drawings are not necessarily to scale.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, procedural, operational, and other changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. Similar structures or components in the various drawings may retain the same or similar numbering for the convenience of the reader; however, any similarity in numbering does not necessarily mean that the structures or components are necessarily identical in size, composition, configuration, or any other property. Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation. It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

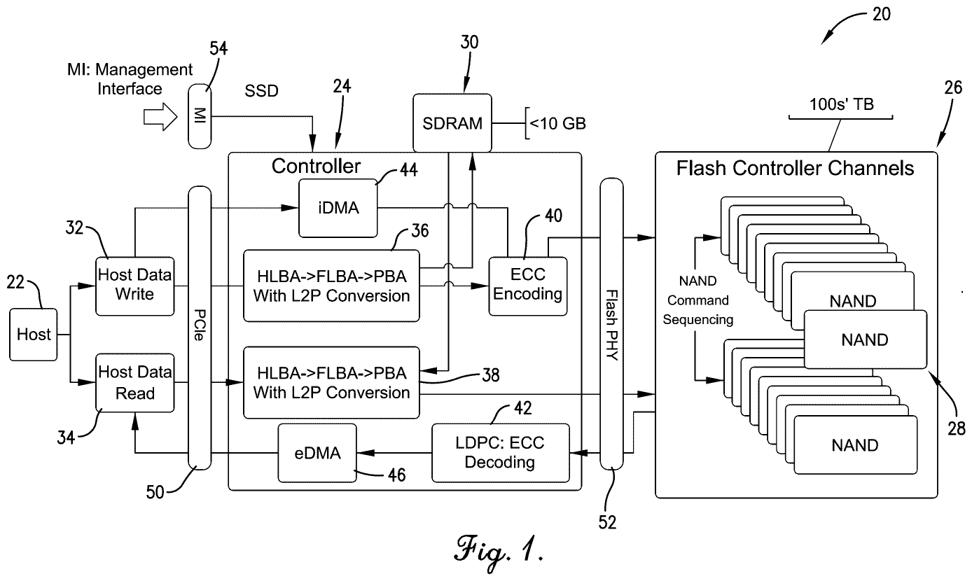

Referring to FIG. 1, a high-level block diagram of components, operations, and an operating context of an example DSD 20 is shown. The illustrated DSD 20 include a host 22 configured to write and read data to and from the DSD 20; a controller 24, such as an ASIC controller, configured to control various DSD operations, such as those discussed below; and an NVM media 26, such as a NAND-based memory media in the form of a plurality of NAND dies 28. Each NAND die may include one or more planes, each plane may include multiple blocks, each block may include multiple pages, and each page may include multiple cells. Each block may be arranged as an array of WLs and BLs, with each WL representing a page. Although described herein with regard to NAND-based memory media, examples may employ substantially any suitable memory array technology, such as NOR-based memory media and dynamic random access memory (DRAM).

Generally, the DSD 20 may operate as follows. A write or read request may be received from the host 22 via a peripheral component interconnect express (PCIe) or other suitable interface 50. PCIe is a standardized interface for motherboard components. The controller 24 may use logical block addresses (LBAs) and physical block addresses (PBAs) to facilitate access for data storage in and retrieval from the NVM 26. LBAs are an abstraction to allow the operating system to interact with the NVM 26, and PBAs represent the actual hardware locations within the NVM 26. To facilitate interacting with the NVM 26, the controller 24 may create an entry or record that assigns an LBA to a PBA. To keep track of all such LBA-to-PBA assignments, the controller 24 may use a logical-to-physical (L2P) mapping table. The L2P table may be uploaded to synchronous dynamic random access memory (SDRAM) 30 so that it can be more quickly accessed and updated by the controller 24. When a write or read data request 32, 34 is received from the host 22, the controller 24 performs a reference operation 36, 38 to the L2P mapping table to determine the PBA within the NVM corresponding to a desired LBA. Once the PBA is determined, the controller 24 accesses the appropriate NVM cell to write or read the data. Access to the NVM 26 may be via a flash physical (PHY) or other suitable interface 52. The controller 24 may employ an error correction code (ECC) operation 40, 42 during encoding and decoding of data to detect and correct errors and enhance data integrity. Additionally, the DSD 20 may support a direct memory access (DMA) operation 44, 46 enabling data to be written from the host 22 directly to the NVM 26 and read from the NVM 26 directly to the host 22.

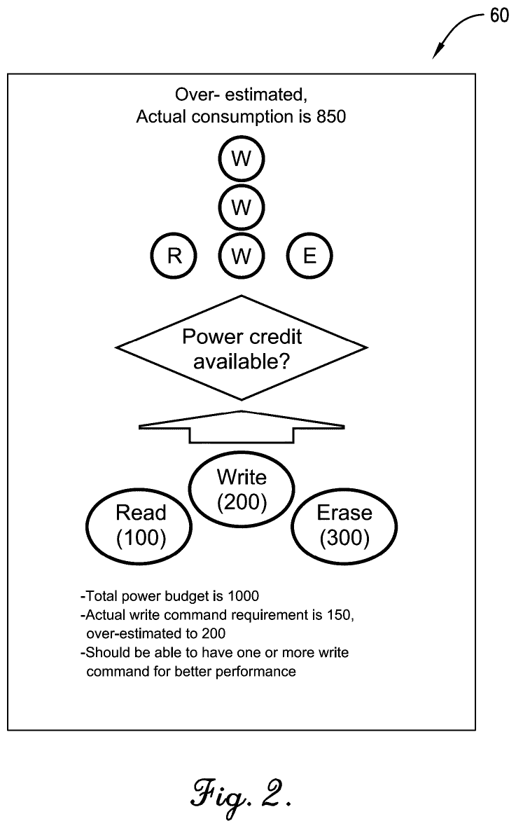

Conventionally, DSD firmware has a fixed power credit allocation for input/output (I/O) commands, such as read, write, and erase commands, and the allocated power credit may over-or under-estimate the actual required power for different scenarios. Over-estimation allocates too much power credit for the I/O commands. In this case, performance and QoS may decrease due to the unnecessary allocation that may crowd out new incoming commands. NAND reliability may be degraded if the command in progress is suspended in order to release its power credit to a higher priority command, such as program-suspend or erase-suspend commands. An illustration of an example over-estimated power credit allocation 60 is shown in FIG. 2, wherein if a read (“R”) command is budgeted one hundred (100) power units, three (3) write (“W”) commands are budgeted two hundred (200) power units each, and an erase (“E”) command is budgeted three hundred (300) power units, which is a total power credit allocation of one thousand (1000) power units, but each write command actually only uses one hundred fifty (150) power units, then the actual power usage is eight hundred fifty (850) power units, which means the power credit allocation was over-estimated by one hundred fifty (150) power units.

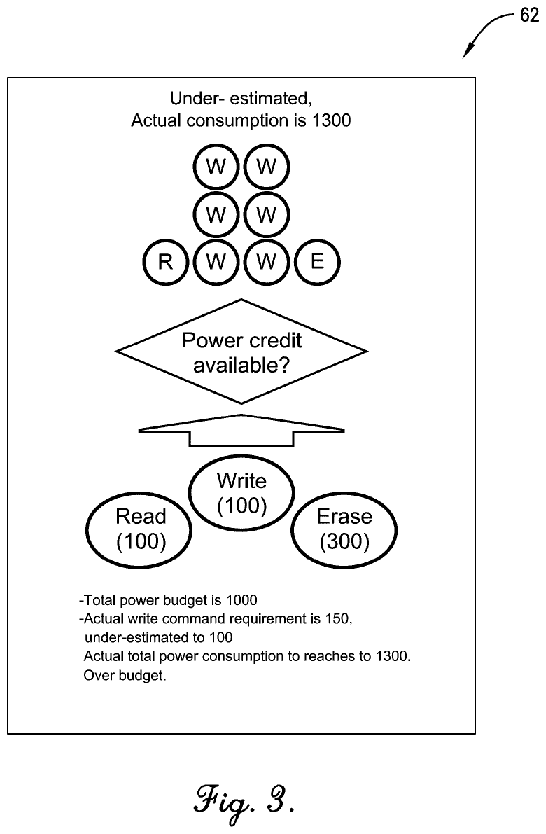

Under-estimation allocates too little power credit for the I/O commands. In this case, each command consumes more power than its budget, total power consumption is over-budget for the system design, and the controller may overheat due to heavy I/O traffic. The error-rate may increase as well. An illustration of an example under-estimated power credit allocation 62 is shown in FIG. 3, wherein if a read command is budgeted one hundred (100) power units, six (6) write commands are budgeted two hundred (100) power units each, and an erase command is budgeted three hundred (300) power units, which is a total power credit allocation of one thousand (1000) power units, but each write command actually uses one hundred fifty (150) power units, then the actual power usage is one thousand three hundred (1300) power units, which means the power credit allocation was under-estimated by three hundred (300) power units.

Examples provide an SSD or other DSD, such as the DSD 20 described above, with adjustable power credit allocation. Examples also provide adjustable power credit allocation in an SSD or other DSD. Broadly, examples dynamically allocate power for NVM operations based on relevant operating characteristics of the drive, such as NAND degradation, which may be determined based on the number of P/E cycles completed by the NVM, and the power consumption of the controller, which may be determined based on the temperature of the controller (which may, in turn, be determined based on the speed with which an erase/program operation is performed). Examples dynamically determine a recommended power credit number for every I/O command, such as read, write, and erase commands, during run-time, such that the outcome more closely aligns with actual power consumption. For example, given a lower number of P/E cycles or a higher controller temperature, the DSD will process a lesser number of read/write requests. Similarly, given a higher number of P/E cycles or a lower controller temperature, the DSD will process a greater number of read/write requests. Examples provide more accurate power allocation which advantageously allows for more accurate power estimation for system level design, improves QoS and media reliability, and reduces the error rate by better managing the temperature of the controller.

Allocating power based on the different operations may be implemented using a lookup table or a formula that correlates the relevant operating characteristics of the drive with the power required to perform the commands. The lookup table may include information relevant to properly determining the power credits, such as the number of P/E cycles completed by the NVM media and the controller temperature. Similarly, the formula may be a function of the command type, the number of P/E cycles, and the controller temperature. The formula may be determined prior to operation based on offline system characterization data. Real-time monitoring of the latencies involved with the different operations under different operating conditions may be used to adjust the power credits accordingly. The relationship between the change in power allocation and the change in temperature and/or P/E cycles may not be linear, and may need to be empirically determined based on the NAND characterization data.

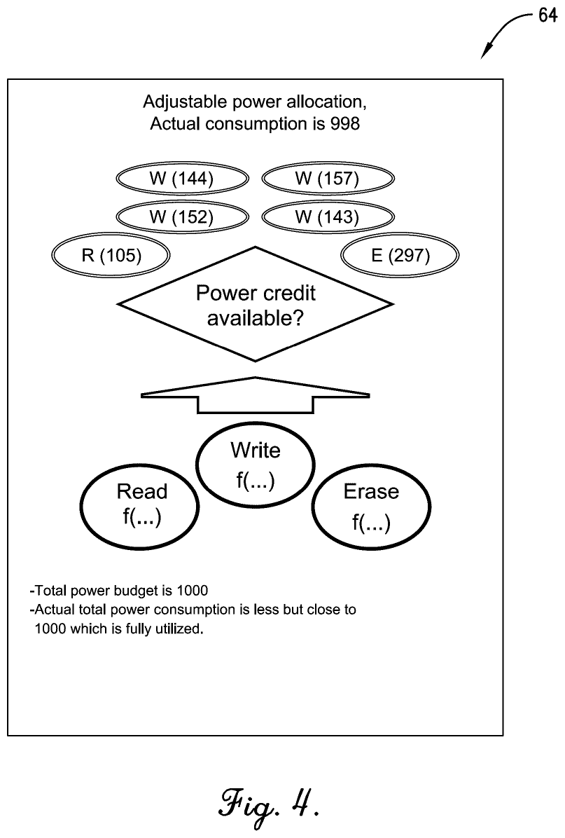

For example, an illustration of an example of a more accurately estimated power credit allocation 64 is shown in FIG. 4, wherein the power requirements for the read, write, and erase commands are estimated based on a plurality of relevant current operating conditions, such as a number of P/E cycles for the NVM media and a current temperature of the controller. This results in a total power credit allocation of one thousand (1000) power units and an actual usage of nine hundred ninety-eight (998) power units, which means the power credit allocation was over-estimated by only two (2) power units.

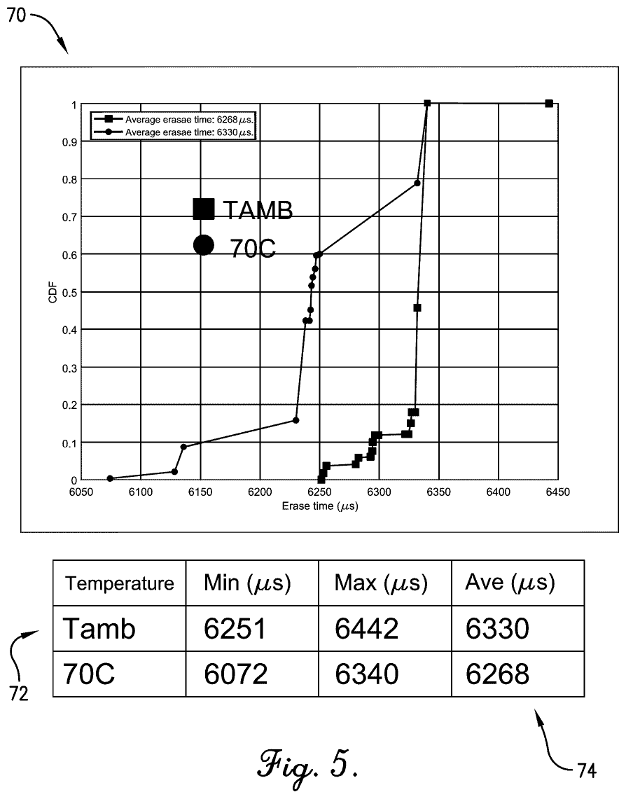

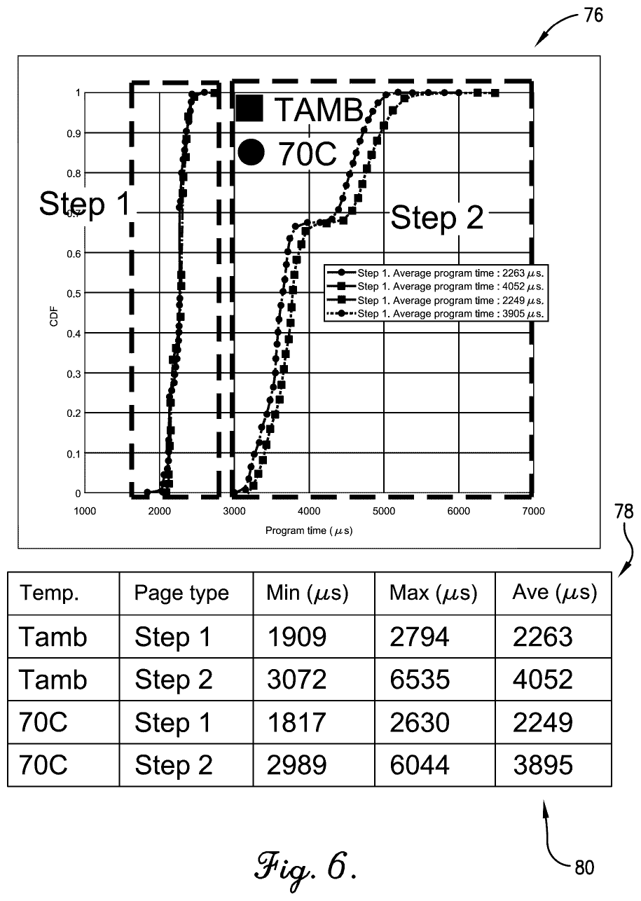

Referring to FIG. 5, a presentation, including a graph 70 and a table 72, is shown demonstrating that, in an example system, a change in a temperature of a controller, from twenty-five (25) degrees Celsius (TAMB) to seventy (70) degrees Celsius, results in a change in an average speed of operation 74 for erasing an NVM media. Relatedly, referring to FIG. 6, a presentation, including a graph 76 and a table 78, is shown demonstrating that the same change in the temperature of the controller results in a change in the average speed of operation 80 for programming the NVM media. More specifically, NAND string current (Icell) is a function of temperature, and for undoped polysilicon (3D NAND), Icell increases as temperature increases. Threshold voltage (Vt) is also a function of temperature, and for undoped polysilicon (3D NAND), Vt decreases as temperature increases and erase/program operations become faster.

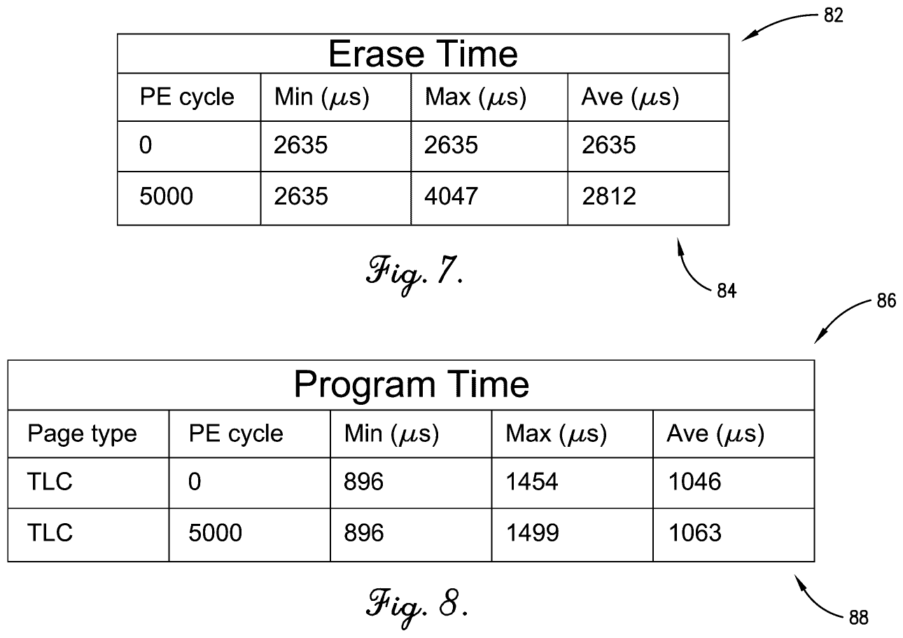

Referring to FIG. 7, a table 82 is shown demonstrating that a change in a number of P/E cycles completed by the NVM media results in a change in the average speed of operation 84 for erasing the NVM media. Relatedly, referring two FIG. 8, a table 86 is shown demonstrating that the same change in the number of P/E cycles completed by the NVM media results in a change in the average speed of operation 88 for programming the NVM media. More specifically, the erase operation is a relatively slow (requiring approximately between five (5) and twenty (20) milliseconds) block level operation, and it involves a relatively high electric field that damages the insulating oxide layer, which degrades reliability and increases the time required to perform the erase-program operation. A program operation on top of an erase operation will cause even more damage to the insulating oxide layers due to high electric field stress during the operation. As the number of completed P/E cycles increases, the program operation becomes slower to maintain the same reliability, so the time required to perform the erase-program operation increases.

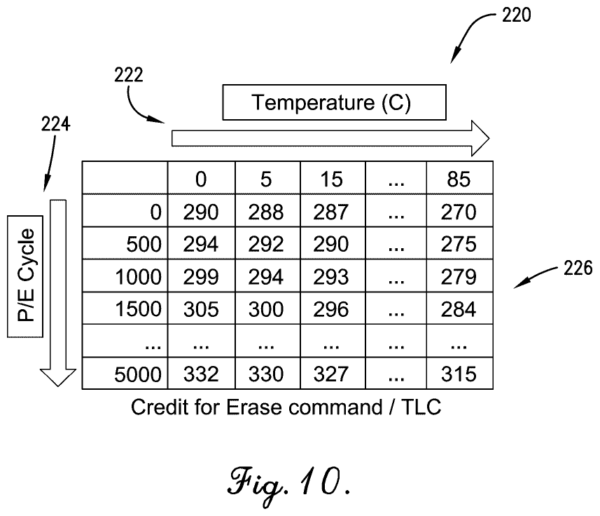

Thus, during operation, the controller 24 may adjust the power credit allocation by performing the following functions. A plurality of relevant operating conditions may be quantified. This may include determining a number of P/E cycles completed by the NVM media 26, and determining a current temperature of the controller 24. A lower number of P/E cycles or a higher temperature (reflected in a shorter erase/program operation time) means that the DSD 20 will process more read and write requests, which may result in the controller 24 adjusting the power credit allocation lower. Conversely, a higher number of P/E cycles or a lower temperature (reflected in a longer erase/program operation time) means that the DSD 20 will process less read and write requests, which may result in the controller 24 adjusting the power credit allocation higher. A plurality of recommended power credit numbers may be determined for a plurality of commands (e.g., read, write, erase) based on the quantified plurality of relevant operating conditions, and the power credit allocation may be adjusted based on the determined plurality of recommended power credit numbers. The power credit allocation may be adjusted using a look-up table (an example of which is shown in FIG. 10 and described below) or using a formula based on the determined plurality of recommended power credit numbers.

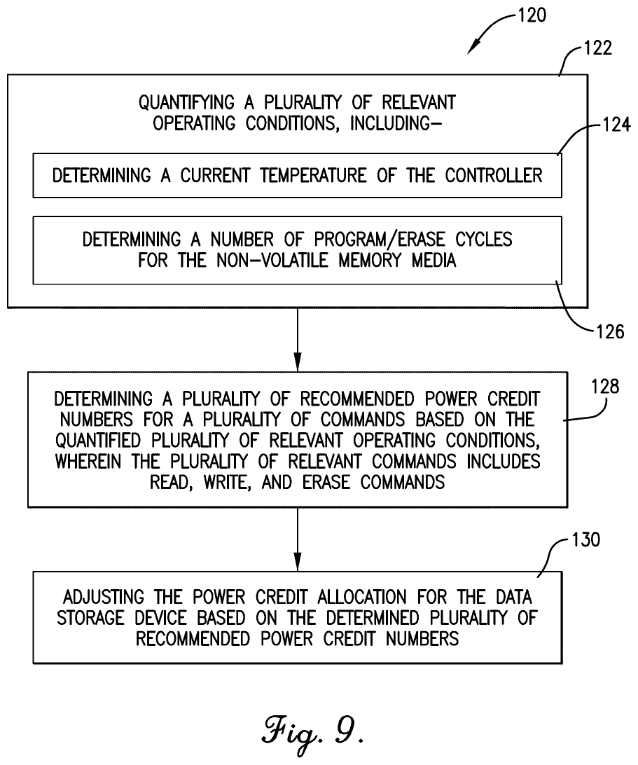

Referring to FIG. 9, an example of a method 120 of adjusting a power credit allocation in a DSD may include the operations set forth below. The DSD may be the example DSD 20 described above, including the controller 24 and the NVM media 26, wherein the controller 24 may be configured to perform a plurality of functions related to data storage and access, including the operations set forth below.

A plurality of relevant operating conditions may be quantified, as shown in 122. This may include determining a number of P/E cycles completed by the NVM media 26, as shown in 124, and determining a current temperature of the controller 24, as shown in 126. A lower number of P/E cycles or a higher temperature (reflected in a shorter erase/program operation time) means that the DSD 20 will process more read and write requests, which may result in the controller 24 adjusting the power credit allocation lower. Conversely, a higher number of P/E cycles or a lower temperature (reflected in a longer erase/program operation time) means that the DSD 20 will process less read and write requests, which may result in the controller 24 adjusting the power credit allocation higher.

A plurality of recommended power credit numbers may be determined for a plurality of commands, including read, write, and erase commands, based on the quantified plurality of relevant operating conditions, as shown in 128. The power credit allocation for the DSD 20 may be adjusted based on the determined plurality of recommended power credit numbers, as shown in 130. The power credit allocation may be adjusted using a look-up table or using a formula based on the determined plurality of recommended power credit numbers. Referring to FIG. 10, an example of a portion of a lookup table 220 for a particular device and a particular application is shown correlating the change in temperature 222 and the change in P/E cycles 224 with the change in recommend power credit numbers 226 for an erase operation.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

1. A data storage device with adjustable power credit allocation, the data storage device comprising:
a non-volatile memory media; and
a controller configured to perform a plurality of functions including
quantifying a plurality of relevant operating conditions, including
determining a number of program/erase cycles completed by the non-volatile memory media, and
determining a temperature of the controller,
determining a plurality of recommended power credit numbers for a plurality of commands based on the plurality of relevant operating conditions, wherein the plurality of relevant commands includes read, write, and erase commands, and
adjusting the power credit allocation for the data storage device based on the plurality of recommended power credit numbers.

2. The data storage device of claim 1, wherein a lower number of program/erase cycles completed by the non-volatile memory media means that the data storage device will process more read and write requests, resulting in the controller adjusting the power credit allocation lower.

3. The data storage device of claim 1, wherein a higher temperature of the controller means that the data storage device will process more read and write requests, resulting in the controller adjusting the power credit allocation lower.

4. The data storage device of claim 1, wherein a higher number of program/erase cycles completed by the non-volatile memory media means that the data storage device will process fewer read and write requests, resulting in the controller adjusting the power credit allocation higher.

5. The data storage device of claim 1, wherein a lower temperature of the controller means that the data storage device will process fewer read and write requests, resulting in the controller adjusting the power credit allocation higher.

6. The data storage device of claim 1, wherein the controller adjusts the power credit allocation using a look-up table based on the plurality of recommended power credit numbers.

7. The data storage device of claim 1, wherein the controller adjusts the power credit allocation using a formula based on the plurality of recommended power credit numbers.

8. A method of adjusting a power credit allocation in a data storage device, the data storage device including a non-volatile memory media and a controller configured to perform a plurality of functions, the method comprising:
quantifying a plurality of relevant operating conditions, including
determining a number of program/erase cycles completed by the non-volatile memory media, and
determining a temperature of the controller;
determining a plurality of recommended power credit numbers for a plurality of commands based on the plurality of relevant operating conditions, wherein the plurality of relevant commands includes read, write, and erase commands; and
adjusting the power credit allocation for the data storage device based on the plurality of recommended power credit numbers.

9. The method of claim 8, wherein a lower number of program/erase cycles completed by the non-volatile memory media means that the data storage device will process more read and write requests, resulting in adjusting the power credit allocation lower.

10. The method of claim 8, wherein a higher temperature of the controller results in adjusting the power credit allocation lower.

11. The method of claim 8, wherein a higher number of program/erase cycles completed by the non-volatile memory media results in adjusting the power credit allocation higher.

12. The method of claim 8, wherein a lower temperature of the controller results in adjusting the power credit allocation higher.

13. The method of claim 8, wherein the power credit allocation is adjusted using a look-up table based on the plurality of recommended power credit numbers.

14. The method of claim 8, wherein the power credit allocation is adjusted using a formula based on the plurality of recommended power credit numbers.

15. A method of adjusting a power credit allocation in a solid-state data storage device, the solid-state data storage device including a NAND-based non-volatile memory media and a controller configured to perform a plurality of functions, the method comprising:
quantifying with the controller a plurality of relevant operating conditions, including
determining a number of program/erase cycles completed by the NAND-based non-volatile memory media, and
determining a temperature of the controller;
determining with the controller a plurality of recommended power credit numbers for a plurality of commands based on the plurality of relevant operating conditions, wherein the plurality of relevant commands includes read, write, and erase commands; and
adjusting with the controller the power credit allocation for the data storage device based on the plurality of recommended power credit numbers.

16. The method of claim 15, wherein
a lower number of program/erase cycles completed by the NAND-based non-volatile memory media means that the solid-state data storage device will process more read and write requests, resulting in the controller adjusting the power credit allocation lower; and
a higher number of program/erase cycles completed by the NAND-based non-volatile memory media means that the solid-state data storage device will process fewer read and write requests, resulting in the controller adjusting the power credit allocation higher.

17. The method of claim 15, wherein
a lower temperature of the controller means that the solid-state data storage device will process fewer read and write requests, resulting in the controller adjusting the power credit allocation higher; and
a higher temperature of the controller means that the solid-state data storage device will process more read and write requests, resulting in the controller adjusting the power credit allocation lower.

18. The method of claim 15, wherein the controller adjusts the power credit allocation using a look-up table based on the plurality of recommended power credit numbers.

19. The method of claim 15, wherein the controller adjusts the power credit allocation using a formula based on the plurality of recommended power credit numbers.
